(19) United States
(12) Patent Application Publication
(10) Pub. No.: US 2025/0340294 A1
(43) Pub. Date: Nov. 6, 2025

(54) Cleaning Structure for Payload Retrieval Apparatus

(71) Applicant: Wing Aviation LLC, Palo Alto, CA (US)

(72) Inventors: Elizabeth Chase Marshman, San Francisco, CA (US); Jesse Hayden Blake, Palo Alto, CA (US); Ivan Qiu, Redwood City, CA (US); Christian Eric Stenbaek Nielsen, Mountain View, CA (US); Jasper Lee Lewin, Santa Cruz, CA (US)

(21) Appl. No.: 18/656,557

(22) Filed: May 6, 2024

(51) Int. Cl. B64D 1/08; B08B 1/12; B08B 1/14; F16N 7/12

(52) U.S. Cl. CPC B64D 1/08; B08B 1/12; B08B 1/14; F16N 7/12; F16N 2210/08

(57) ABSTRACT

A cleaning structure for a payload retrieval apparatus includes a main body having an upper end and a lower end. The upper end includes a tether attachment point. The cleaning structure also includes a first cleaning component extending outward from the main body. The first cleaning component has a flexible construction for fitting into crevices in the payload retrieval apparatus and defines a cleaning zone around the main body.

### BACKGROUND

An uncrewed vehicle, which may also be referred to as an autonomous vehicle, is a vehicle capable of travel without a physically-present human operator. The term “unmanned” may sometimes be used instead of, or in addition to, “uncrewed,” and it should be understood that both terms have the same meaning, and may be used interchangeably. An uncrewed vehicle may operate in a remote-control mode, in an autonomous mode, or in a partially autonomous mode.

When an uncrewed vehicle operates in a remote-control mode, a pilot or driver that is at a remote location can control the uncrewed vehicle via commands that are sent to the uncrewed vehicle via a wireless link. When the uncrewed vehicle operates in autonomous mode, the uncrewed vehicle typically moves based on pre-programmed navigation waypoints, dynamic automation systems, or a combination of these. Further, some uncrewed vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of uncrewed vehicles exist for various different environments. For instance, uncrewed vehicles exist for operation in the air, on the ground, underwater, and in space. Examples include quad-copters and tail-sitter UAVs, among others. Uncrewed vehicles also exist for hybrid operations in which multi-environment operation is possible. Examples of hybrid uncrewed vehicles include an amphibious craft that is capable of operation on land as well as on water or a floatplane that is capable of landing on water as well as on land. Other examples are also possible.

### SUMMARY

The present embodiments are directed to a cleaning structure, a system and a method for cleaning portions of a payload retrieval apparatus, such as a retriever guide that directs a payload retriever to a payload. The cleaning structure is configured to be drawn through the retriever guide on a tether and to clean the structure as it moves through the retriever guide.

In one aspect a cleaning structure for a payload retrieval apparatus is provided. The cleaning structure includes a main body having an upper end and a lower end. The upper end includes a tether attachment point. A first cleaning component extends outward from the main body. The first cleaning component has a flexible construction for fitting into crevices in the payload retrieval apparatus and defines a cleaning zone around the main body.

In another aspect, a system for cleaning a payload retrieval apparatus is provided. The system includes an aerial vehicle, a tether secured to the aerial vehicle, a motor operable to deploy the tether from the aerial vehicle, and a cleaning structure attached to the tether. The cleaning structure includes a main body having an upper end and a lower end. The upper end includes a tether attachment point. A first cleaning component extends outward from the main body. The first cleaning component has a flexible construction for fitting into crevices in the payload retrieval apparatus and defines a cleaning zone around the main body.

In another aspect, a method of cleaning a retriever guide of a payload retrieval apparatus is provided. The method includes initiating, by a controller, a cleaning operation. The cleaning operation includes controlling a motor to extend a tether from an aerial vehicle so as to lower a cleaning structure attached to the tether to a position below an inlet end of a channel of a retriever guide of the payload retrieval apparatus. The cleaning operation also includes controlling the position of the aerial vehicle and the motor to draw the cleaning structure into the inlet end of the channel of the retriever guide. The motor is also controlled to pull the cleaning structure through the channel of the retriever guide.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1A is a simplified illustration of an uncrewed aerial vehicle, according to an example embodiment.

FIG. 1B is a simplified illustration of an uncrewed aerial vehicle, according to an example embodiment.

FIG. 1C is a simplified illustration of an uncrewed aerial vehicle, according to an example embodiment.

FIG. 1D is a simplified illustration of an uncrewed aerial vehicle, according to an example embodiment.

FIG. 1E is a simplified illustration of an uncrewed aerial vehicle, according to an example embodiment.

FIG. 2 is a simplified block diagram illustrating components of an uncrewed aerial vehicle, according to an example embodiment.

FIG. 3 is a simplified block diagram illustrating a UAV system, according to an example embodiment.

FIGS. 4A, 4B, and 4C show a payload delivery apparatus, according to an example embodiment.

FIG. 5 shows a perspective view of a payload delivery apparatus according to an example embodiment.

FIG. 6 shows a perspective view of a payload coupling apparatus according to an example embodiment.

FIG. 7 shows a side view of a handle of a payload according to an example embodiment.

FIG. 8 shows a pair of locking pins engaging a handle of a payload according to an example embodiment.

FIG. 9 is a perspective view of payload retrieval apparatus according to an example embodiment.

FIG. 10 shows a sequence of steps A-D performed in the retrieval of a payload from the payload retrieval apparatus of FIG. 9.

FIG. 11A is a side cross-sectional view of a retriever guide of the payload retrieval apparatus of FIG. 9.

FIG. 11B is a perspective view of the inlet side of the retriever guide of FIG. 11A.

FIG. 11C is a perspective view of the exit side of the retriever guide of FIG. 11A.

FIG. 12 is a detailed cross-sectional view of a payload retriever passing through the exit of the retriever guide of FIG. 11A.

FIG. 13 is a side cross-sectional view of a cleaning structure being drawn through the retriever guide of FIG. 11A.

FIGS. 14A-14C show a cleaning structure according to an example embodiment.

FIG. 15 is a side view of a cleaning structure according to another example embodiment.

FIG. 16 is a side view of a cleaning structure according to yet another example embodiment.

FIG. 17 is a side view of a cleaning structure according to another example embodiment.

FIGS. 18A-18C show a cleaning structure including a reservoir according to another example embodiment.

### DETAILED DESCRIPTION

Exemplary methods and systems are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

### I. Overview

The present embodiments are related to a cleaning structure for cleaning a payload retrieval apparatus, and methods of cleaning a payload retrieval apparatus. The cleaning structure is configured to enable cleaning of a payload retrieval apparatus using an aerial vehicle, particularly an uncrewed aerial vehicle. The cleaning structure is deployed on a tether from the aerial vehicle and is drawn through the payload retrieval apparatus in a manner similar to a payload retriever. The cleaning structure includes one or more cleaning components on its surface and engages interior surfaces in a channel of the payload retrieval apparatus to remove dirt and debris. The cleaning structure may also be configured to deliver a fluid, such as a cleaning solution or a lubricant to the payload retrieval apparatus as it is drawn through the channel.

Further details and other embodiments of a cleaning according to the disclosure are described in more detail below.

### II. Illustrative Uncrewed Vehicles

Herein, the terms “uncrewed aerial vehicle” and “UAV” refer to any autonomous or semi-autonomous vehicle that is capable of performing some functions without a physically present human pilot.

A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), or “uncrewed aerial system” (UAS) may also be used to refer to a UAV.

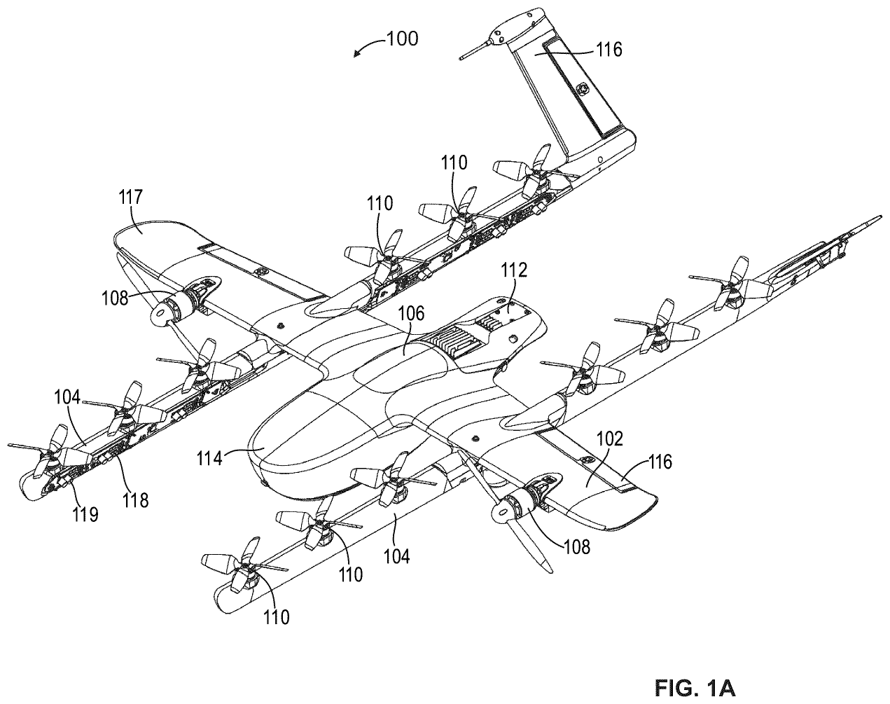

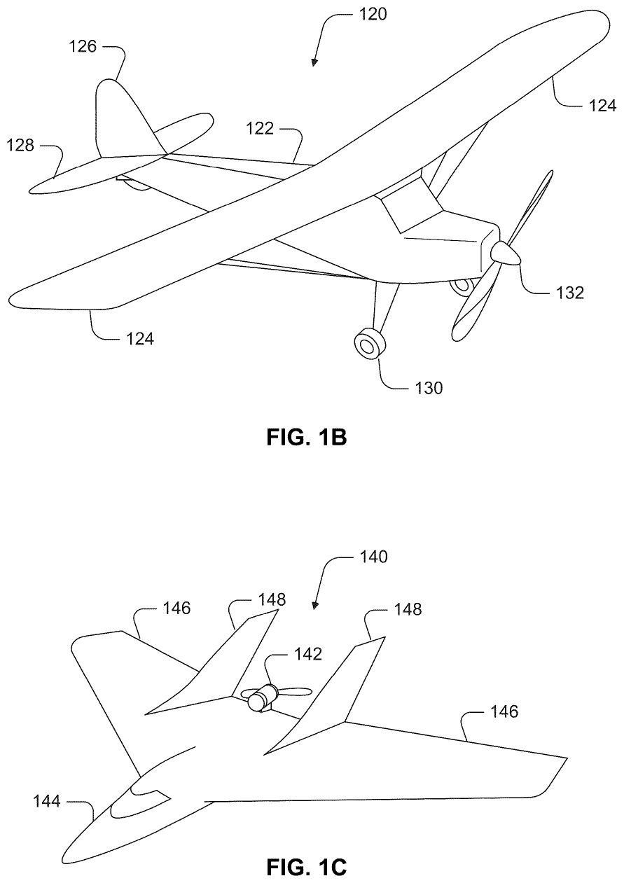

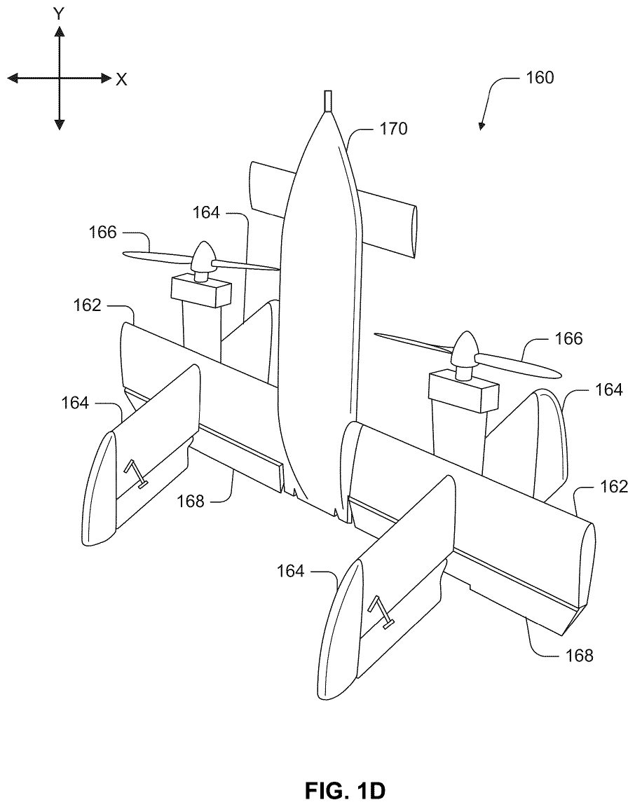

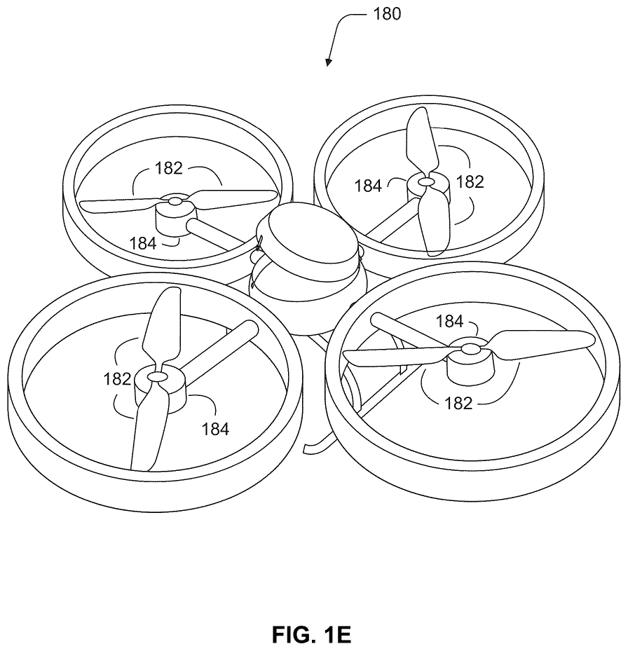

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1A illustrates two wings 102, two booms 104, two horizontal propulsion units 108, and six vertical propulsion units 110 per boom 104, it should be appreciated that other variants of UAV 100 may be implemented with more or fewer of these components. For example, UAV 100 may include four wings 102, four booms 104, and more or fewer propulsion units (horizontal or vertical).

Similarly, FIG. 1B shows another example of a fixed-wing UAV 120. The fixed-wing UAV 120 includes a fuselage 122, two wings 124 with an airfoil-shaped cross section to provide lift for the UAV 120, a vertical stabilizer 126 (or fin) to stabilize the plane's yaw (turn left or right), a horizontal stabilizer 128 (also referred to as an elevator or tailplane) to stabilize pitch (tilt up or down), landing gear 130, and a propulsion unit 132, which can include a motor, shaft, and propeller.

FIG. 1C shows an example of a UAV 140 with a propeller in a pusher configuration. The term “pusher” refers to the fact that a propulsion unit 142 is mounted at the back of the UAV and “pushes” the vehicle forward, in contrast to the propulsion unit being mounted at the front of the UAV. Similar to the description provided for FIGS. 1A and 1B, FIG. 1C depicts common structures used in a pusher plane, including a fuselage 144, two wings 146, vertical stabilizers 148, and the propulsion unit 142, which can include a motor, shaft, and propeller.

FIG. 1D shows an example of a tail-sitter UAV 160. In the illustrated example, the tail-sitter UAV 160 has fixed wings 162 to provide lift and allow the UAV 160 to glide horizontally (e.g., along the x-axis, in a position that is approximately perpendicular to the position shown in FIG. 1D). However, the fixed wings 162 also allow the tail-sitter UAV 160 to take off and land vertically on its own.

For example, at a launch site, the tail-sitter UAV 160 may be positioned vertically (as shown) with its fins 164 and/or wings 162 resting on the ground and stabilizing the UAV 160 in the vertical position. The tail-sitter UAV 160 may then take off by operating its propellers 166 to generate an upward thrust (e.g., a thrust that is generally along the y-axis). Once at a suitable altitude, the tail-sitter UAV 160 may use its flaps 168 to reorient itself in a horizontal position, such that its fuselage 170 is closer to being aligned with the x-axis than the y-axis. Positioned horizontally, the propellers 166 may provide forward thrust so that the tail-sitter UAV 160 can fly in a similar manner as a typical airplane.

As noted above, some embodiments may involve other types of UAVs, in addition to or in the alternative to fixed-wing UAVs. For instance, FIG. 1E shows an example of a rotorcraft that is commonly referred to as a multicopter 180. The multicopter 180 may also be referred to as a quadcopter, as it includes four rotors 182. It should be understood that example embodiments may involve a rotorcraft with more or fewer rotors than the multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to the multicopter 180 in greater detail, the four rotors 182 provide propulsion and maneuverability for the multicopter 180. More specifically, each rotor 182 includes blades that are attached to a motor 184. Configured as such, the rotors 182 may allow the multicopter 180 to take off and land vertically, to maneuver in any direction, and/or to hover. Further, the pitch of the blades may be adjusted as a group and/or differentially, and may allow the multicopter 180 to control its pitch, roll, yaw, and/or altitude.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Illustrative UAV Components

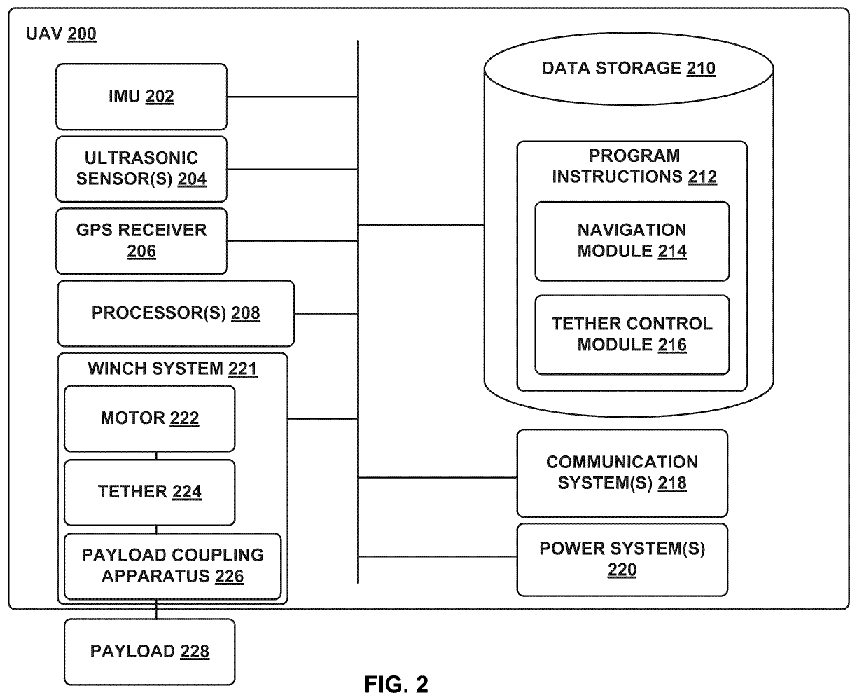

FIG. 2 is a simplified block diagram illustrating components of a UAV 200, according to an example embodiment. UAV 200 may take the form of, or be similar in form to, one of the UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include an inertial measurement unit (IMU) 202, ultrasonic sensor(s) 204, and a GPS 206, among other possible sensors and sensing systems.

In the illustrated embodiment, UAV 200 also includes one or more processors 208. A processor 208 may be a general-purpose processor or a special purpose processor (e.g., digital signal processors, application specific integrated circuits, etc.). The one or more processors 208 can be configured to execute computer-readable program instructions 212 that are stored in the data storage 210 and are executable to provide the functionality of a UAV described herein.

The data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of the one or more processors 208. In some embodiments, the data storage 210 can be implemented using a single physical device (e.g., one optical, magnetic, organic or other memory or disc storage unit), while in other embodiments, the data storage 210 can be implemented using two or more physical devices.

As noted, the data storage 210 can include computer-readable program instructions 212 and perhaps additional data, such as diagnostic data of the UAV 200. As such, the data storage 210 may include program instructions 212 to perform or facilitate some or all of the UAV functionality described herein. For instance, in the illustrated embodiment, program instructions 212 include a navigation module 214 and a tether control module 216.

### A. Sensors

In an illustrative embodiment, IMU 202 may include both an accelerometer and a gyroscope, which may be used together to determine an orientation of the UAV 200. In particular, the accelerometer can measure the orientation of the vehicle with respect to earth, while the gyroscope measures the rate of rotation around an axis. IMUs are commercially available in low-cost, low-power packages. For instance, an IMU 202 may take the form of or include a miniaturized MicroElectroMechanical System (MEMS) or a NanoElectroMechanical System (NEMS). Other types of IMUs may also be utilized.

An IMU 202 may include other sensors, in addition to accelerometers and gyroscopes, which may help to better determine position and/or help to increase autonomy of the UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of the UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

UAV 200 may also include a GPS receiver 206. The GPS receiver 206 may be configured to provide data that is typical of well-known GPS systems, such as the GPS coordinates of the UAV 200. Such GPS data may be utilized by the UAV 200 for various functions. As such, the UAV may use its GPS receiver 206 to help navigate to the caller's location, as indicated, at least in part, by the GPS coordinates provided by their mobile device. Other examples are also possible.

### B. Navigation and Location Determination

The navigation module 214 may provide functionality that allows the UAV 200 to, e.g., move about its environment and reach a desired location. To do so, the navigation module 214 may control the altitude and/or direction of flight by controlling the mechanical features of the UAV that affect flight (e.g., its rudder(s), elevator(s), aileron(s), and/or the speed of its propeller(s)).

In order to navigate the UAV 200 to a target location, the navigation module 214 may implement various navigation techniques, such as map-based navigation and localization-based navigation, for instance. With map-based navigation, the UAV 200 may be provided with a map of its environment, which may then be used to navigate to a particular location on the map. With localization-based navigation, the UAV 200 may be capable of navigating in an unknown environment using localization. Localization-based navigation may involve the UAV 200 building its own map of its environment and calculating its position within the map and/or the position of objects in the environment. For example, as a UAV 200 moves throughout its environment, the UAV 200 may continuously use localization to update its map of the environment. This continuous mapping process may be referred to as simultaneous localization and mapping (SLAM). Other navigation techniques may also be utilized.

In some embodiments, the navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, the navigation module 214 and/or other components and systems of the UAV 200 may be configured for “localization” to more precisely navigate to the scene of a target location. More specifically, it may be desirable in certain situations for a UAV to be within a threshold distance of the target location where a payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, the UAV 200 may navigate to the general area of a target destination where a payload 228 is being delivered using waypoints and/or map-based navigation. The UAV may then switch to a mode in which it utilizes a localization process to locate and travel to a more specific location. For instance, if the UAV 200 is to deliver a payload to a user's home, the UAV 200 may need to be substantially close to the target location in order to avoid delivery of the payload to undesired areas (e.g., onto a roof, into a pool, onto a neighbor's property, etc.). However, a GPS signal may only get the UAV 200 so far (e.g., within a block of the user's home). A more precise location-determination technique may then be used to find the specific target location.

Various types of location-determination techniques may be used to accomplish localization of the target delivery location once the UAV 200 has navigated to the general area of the target delivery location. For instance, the UAV 200 may be equipped with one or more sensory systems, such as, for example, ultrasonic sensors 204, infrared sensors (not shown), and/or other sensors, which may provide input that the navigation module 214 utilizes to navigate autonomously or semi-autonomously to the specific target location.

As another example, once the UAV 200 reaches the general area of the target delivery location (or of a moving subject such as a person or their mobile device), the UAV 200 may switch to a “fly-by-wire” mode where it is controlled, at least in part, by a remote operator, who can navigate the UAV 200 to the specific target location. To this end, sensory data from the UAV 200 may be sent to the remote operator to assist them in navigating the UAV 200 to the specific location.

As yet another example, the UAV 200 may include a module that is able to signal to a passer-by for assistance in either reaching the specific target delivery location; for example, the UAV 200 may display a visual message requesting such assistance in a graphic display, play an audio message or tone through speakers to indicate the need for such assistance, among other possibilities. Such a visual or audio message might indicate that assistance is needed in delivering the UAV 200 to a particular person or a particular location, and might provide information to assist the passer-by in delivering the UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once the UAV 200 arrives at the general area of a target delivery location, the UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, the UAV 200 may be configured to navigate by “sourcing” such directional signals-in other words, by determining where the signal is strongest and navigating accordingly. As another example, a mobile device can emit a frequency, either in the human range or outside the human range, and the UAV 200 can listen for that frequency and navigate accordingly. As a related example, if the UAV 200 is listening for spoken commands, then the UAV 200 could utilize spoken statements, such as “I'm over here!” to source the specific location of the person requesting delivery of a payload.

In an alternative arrangement, a navigation module may be implemented at a remote computing device, which communicates wirelessly with the UAV 200. The remote computing device may receive data indicating the operational state of the UAV 200, sensor data from the UAV 200 that allows it to assess the environmental conditions being experienced by the UAV 200, and/or location information for the UAV 200. Provided with such information, the remote computing device may determine latitudinal and/or directional adjustments that should be made by the UAV 200 and/or may determine how the UAV 200 should adjust its mechanical features (e.g., its rudder(s), elevator(s), aileron(s), and/or the speed of its propeller(s)) in order to effectuate such movements. The remote computing system may then communicate such adjustments to the UAV 200 so it can move in the determined manner.

### C. Communication Systems

In a further aspect, the UAV 200 includes one or more communication systems 218. The communications systems 218 may include one or more wireless interfaces and/or one or more wireline interfaces, which allow the UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, a UAV 200 may include communication systems 218 that allow for both short-range communication and long-range communication. For example, the UAV 200 may be configured for short-range communications using Bluetooth and for long-range communications under a CDMA protocol. In such an embodiment, the UAV 200 may be configured to function as a “hot spot;” or in other words, as a gateway or proxy between a remote support device and one or more data networks, such as a cellular network and/or the Internet. Configured as such, the UAV 200 may facilitate data communications that the remote support device would otherwise be unable to perform by itself.

For example, the UAV 200 may provide a WiFi connection to a remote device, and serve as a proxy or gateway to a cellular service provider's data network, which the UAV might connect to under an LTE or a 3G protocol, for instance. The UAV 200 could also serve as a proxy or gateway to a high-altitude balloon network, a satellite network, or a combination of these networks, among others, which a remote device might not be able to otherwise access.

### D. Power Systems

In a further aspect, the UAV 200 may include power system(s) 220. The power system 220 may include one or more batteries for providing power to the UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

### E. Payload Delivery

The UAV 200 may employ various systems and configurations in order to transport and deliver a payload 228. In some implementations, the payload 228 of a given UAV 200 may include or take the form of a “package” designed to transport various goods to a target delivery location. For example, the UAV 200 can include a compartment, in which an item or items may be transported. Such a package may include one or more food items, purchased goods, medical items, or any other object(s) having a size and weight suitable to be transported between two locations by the UAV. In other embodiments, a payload 228 may simply be the one or more items that are being delivered (e.g., without any package housing the items).

In some embodiments, the payload 228 may be attached to the UAV and located substantially outside of the UAV during some or all of a flight by the UAV. For example, the package may be tethered or otherwise releasably attached below the UAV during flight to a target location. In some embodiments, the package may include various features that protect its contents from the environment, reduce aerodynamic drag on the system, and prevent the contents of the package from shifting during UAV flight. In other embodiments, the package may be a standard shipping package that is not specifically tailored for UAV flight.

In order to deliver the payload, the UAV may include a winch system 221 controlled by the tether control module 216 in order to lower the payload 228 to the ground while the UAV hovers above. As shown in FIG. 2, the winch system 221 may include a tether 224, and the tether 224 may be coupled to the payload 228 by a payload retriever 226. The tether 224 may be wound on a spool that is coupled to a motor 222 of the UAV. The motor 222 may take the form of a DC motor (e.g., a servo motor) that can be actively controlled by a speed controller. The tether control module 216 can control the speed controller to cause the motor 222 to rotate the spool, thereby unwinding or retracting the tether 224 and lowering or raising the payload retriever 226. In practice, the speed controller may output a desired operating rate (e.g., a desired RPM) for the spool, which may correspond to the speed at which the tether 224 and payload 228 should be lowered towards the ground. The motor 222 may then rotate the spool so that it maintains the desired operating rate.

In order to control the motor 222 via the speed controller, the tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as the motor 222 causes rotation of the spool, a rotary encoder may be used to measure this rotation. In doing so, the rotary encoder may be used to convert a rotary position to an analog or digital electronic signal used by the tether control module 216 to determine the amount of rotation of the spool from a fixed reference angle and/or to an analog or digital electronic signal that is representative of a new rotary position, among other options. Other examples are also possible.

Based on the data from the speed sensor, the tether control module 216 may determine a rotational speed of the motor 222 and/or the spool and responsively control the motor 222 (e.g., by increasing or decreasing an electrical current supplied to the motor 222) to cause the rotational speed of the motor 222 to match a desired speed. When adjusting the motor current, the magnitude of the current adjustment may be based on a proportional-integral-derivative (PID) calculation using the determined and desired speeds of the motor 222. For instance, the magnitude of the current adjustment may be based on a present difference, a past difference (based on accumulated error over time), and a future difference (based on current rates of change) between the determined and desired speeds of the spool.

In some embodiments, the tether control module 216 may vary the rate at which the tether 224 and payload 228 are lowered to the ground. For example, the speed controller may change the desired operating rate according to a variable deployment-rate profile and/or in response to other factors in order to change the rate at which the payload 228 descends toward the ground. To do so, the tether control module 216 may adjust an amount of braking or an amount of friction that is applied to the tether 224. For example, to vary the tether deployment rate, the UAV 200 may include friction pads that can apply a variable amount of pressure to the tether 224. As another example, the UAV 200 can include a motorized braking system that varies the rate at which the spool lets out the tether 224. Such a braking system may take the form of an electromechanical system in which the motor 222 operates to slow the rate at which the spool lets out the tether 224. Further, the motor 222 may vary the amount by which it adjusts the speed (e.g., the RPM) of the spool, and thus may vary the deployment rate of the tether 224. Other examples are also possible.

In some embodiments, the tether control module 216 may be configured to limit the motor current supplied to the motor 222 to a maximum value. With such a limit placed on the motor current, there may be situations where the motor 222 cannot operate at the desired rate specified by the speed controller. For instance, as discussed in more detail below, there may be situations where the speed controller specifies a desired operating rate at which the motor 222 should retract the tether 224 toward the UAV 200, but the motor current may be limited such that a large enough downward force on the tether 224 would counteract the retracting force of the motor 222 and cause the tether 224 to unwind instead. And as further discussed below, a limit on the motor current may be imposed and/or altered depending on an operational state of the UAV 200.

In some embodiments, the tether control module 216 may be configured to determine a status of the tether 224 and/or the payload 228 based on the amount of current supplied to the motor 222. For instance, if a downward force is applied to the tether 224 (e.g., if the payload 228 is attached to the tether 224 or if the tether 224 gets snagged on an object when retracting toward the UAV 200), the tether control module 216 may need to increase the motor current in order to cause the determined rotational speed of the motor 222 and/or spool to match the desired speed. Similarly, when the downward force is removed from the tether 224 (e.g., upon delivery of the payload 228 or removal of a tether snag), the tether control module 216 may need to decrease the motor current in order to cause the determined rotational speed of the motor 222 and/or spool to match the desired speed. As such, the tether control module 216 may be configured to monitor the current supplied to the motor 222. For instance, the tether control module 216 could determine the motor current based on sensor data received from a current sensor of the motor or a current sensor of the power system 220. In any case, based on the current supplied to the motor 222, determine if the payload 228 is attached to the tether 224, if someone or something is pulling on the tether 224, and/or if the payload retriever 226 is pressing against the UAV 200 after retracting the tether 224. Other examples are possible as well.

During delivery of the payload 228, the payload retriever 226 can be configured to secure the payload 228 while being lowered from the UAV by the tether 224, and can be further configured to release the payload 228 upon reaching ground level. The payload retriever 226 can then be retracted to the UAV by reeling in the tether 224 using the motor 222.

In some implementations, the payload 228 may be passively released once it is lowered to the ground. For example, a passive release mechanism may include one or more swing arms adapted to retract into and extend from a housing. An extended swing arm may form a hook on which the payload 228 may be attached. Upon lowering the release mechanism and the payload 228 to the ground via a tether, a gravitational force as well as a downward inertial force on the release mechanism may cause the payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of the payload 228 no longer forces the swing arm to extend from the housing. Retracting the swing arm into the housing may reduce the likelihood of the release mechanism snagging the payload 228 or other nearby objects when raising the release mechanism toward the UAV upon delivery of the payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, a UAV 200 could include an air-bag drop system or a parachute drop system. Alternatively, a UAV 200 carrying a payload could simply land on the ground at a delivery location. Other examples are also possible.

### IV. Illustrative UAV Deployment Systems

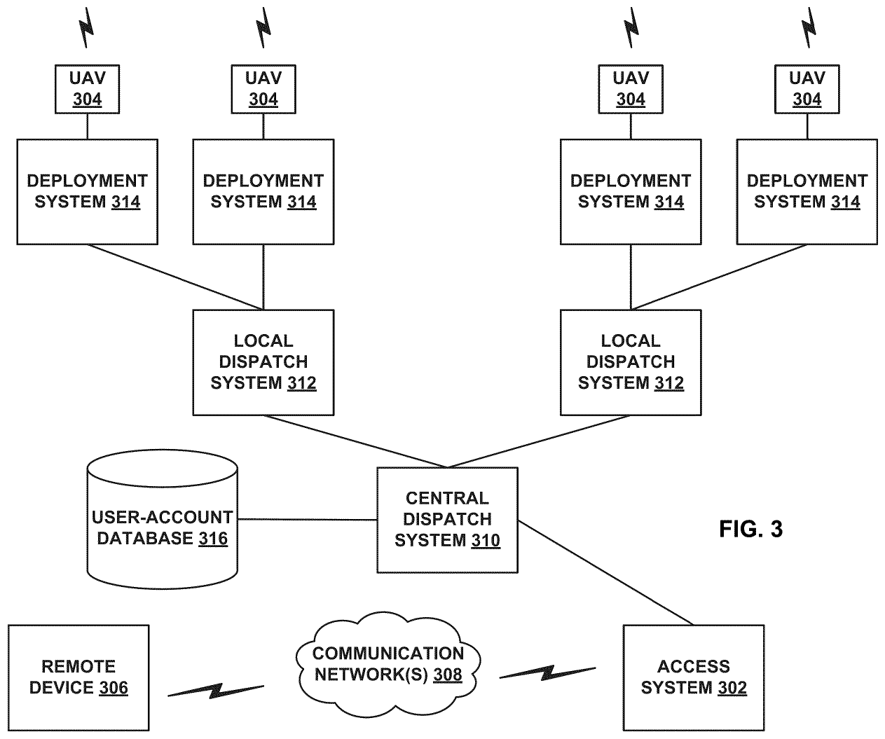

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, an access system 302 may allow for interaction with, control of, and/or utilization of a network of UAVs 304. In some embodiments, an access system 302 may be a computing system that allows for human-controlled dispatch of UAVs 304. As such, the control system may include or otherwise provide a user interface through which a user can access and/or control the UAVs 304.

In some embodiments, dispatch of the UAVs 304 may additionally or alternatively be accomplished via one or more automated processes. For instance, the access system 302 may dispatch one of the UAVs 304 to transport a payload to a target location, and the UAV may autonomously navigate to the target location by utilizing various on-board sensors, such as a GPS receiver and/or other various navigational sensors.

Further, the access system 302 may provide for remote operation of a UAV. For instance, the access system 302 may allow an operator to control the flight of a UAV via its user interface. As a specific example, an operator may use the access system 302 to dispatch a UAV 304 to a target location. The UAV 304 may then autonomously navigate to the general area of the target location. At this point, the operator may use the access system 302 to take control of the UAV 304 and navigate the UAV to the target location (e.g., to a particular person to whom a payload is being transported). Other examples of remote operation of a UAV are also possible.

In an illustrative embodiment, the UAVs 304 may take various forms. For example, each of the UAVs 304 may be a UAV such as those illustrated in FIGS. 1A-1E. However, UAV system 300 may also utilize other types of UAVs without departing from the scope of the invention. In some implementations, all of the UAVs 304 may be of the same or a similar configuration. However, in other implementations, the UAVs 304 may include a number of different types of UAVs. For instance, the UAVs 304 may include a number of types of UAVs, with each type of UAV being configured for a different type or types of payload delivery capabilities.

The UAV system 300 may further include a remote device 306, which may take various forms. Generally, the remote device 306 may be any device through which a direct or indirect request to dispatch a UAV can be made. (Note that an indirect request may involve any communication that may be responded to by dispatching a UAV, such as requesting a package delivery). In an example embodiment, the remote device 306 may be a mobile phone, tablet computer, laptop computer, personal computer, or any network-connected computing device. Further, in some instances, the remote device 306 may not be a computing device. As an example, a standard telephone, which allows for communication via plain old telephone service (POTS), may serve as the remote device 306. Other types of remote devices are also possible.

Further, the remote device 306 may be configured to communicate with access system 302 via one or more types of communication network(s) 308. For example, the remote device 306 may communicate with the access system 302 (or a human operator of the access system 302) by communicating over a POTS network, a cellular network, and/or a data network such as the Internet. Other types of networks may also be utilized.

In some embodiments, the remote device 306 may be configured to allow a user to request delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, the UAV system 300 may receive location information (e.g., GPS coordinates, etc.) from the user's mobile phone, or any other device on the user's person, such that a UAV can navigate to the user's location (as indicated by their mobile phone).

In an illustrative arrangement, the central dispatch system 310 may be a server or group of servers, which is configured to receive dispatch messages requests and/or dispatch instructions from the access system 302. Such dispatch messages may request or instruct the central dispatch system 310 to coordinate the deployment of UAVs to various target locations. The central dispatch system 310 may be further configured to route such requests or instructions to one or more local dispatch systems 312. To provide such functionality, the central dispatch system 310 may communicate with the access system 302 via a data network, such as the Internet or a private network that is established for communications between access systems and automated dispatch systems.

In the illustrated configuration, the central dispatch system 310 may be configured to coordinate the dispatch of UAVs 304 from a number of different local dispatch systems 312. As such, the central dispatch system 310 may keep track of which UAVs 304 are located at which local dispatch systems 312, which UAVs 304 are currently available for deployment, and/or which services or operations each of the UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when the central dispatch system 310 receives a request for UAV-related service (e.g., transport of an item) from the access system 302, the central dispatch system 310 may select a specific UAV 304 to dispatch. The central dispatch system 310 may accordingly instruct the local dispatch system 312 that is associated with the selected UAV to dispatch the selected UAV. The local dispatch system 312 may then operate its associated deployment system 314 to launch the selected UAV. In other cases, the central dispatch system 310 may forward a request for a UAV-related service to a local dispatch system 312 that is near the location where the support is requested and leave the selection of a particular UAV 304 to the local dispatch system 312.

In an example configuration, the local dispatch system 312 may be implemented as a computing system at the same location as the deployment system(s) 314 that it controls. For example, the local dispatch system 312 may be implemented by a computing system installed at a building, such as a warehouse, where the deployment system(s) 314 and UAV(s) 304 that are associated with the particular local dispatch system 312 are also located. In other embodiments, the local dispatch system 312 may be implemented at a location that is remote to its associated deployment system(s) 314 and UAV(s) 304.

Numerous variations on, and alternatives to, the illustrated configuration of the UAV system 300 are possible. For example, in some embodiments, a user of the remote device 306 could request delivery of a package directly from the central dispatch system 310. To do so, an application may be implemented on the remote device 306 that allows the user to provide information regarding a requested delivery, and generate and send a data message to request that the UAV system 300 provide the delivery. In such an embodiment, the central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to the central dispatch system 310, the local dispatch system(s) 312, the access system 302, and/or the deployment system(s) 314 may be combined in a single system, implemented in a more complex system, and/or redistributed among the central dispatch system 310, the local dispatch system(s) 312, the access system 302, and/or the deployment system(s) 314 in various ways.

Yet further, while each local dispatch system 312 is shown as having two associated deployment systems 314, a given local dispatch system 312 may alternatively have more or fewer associated deployment systems 314. Similarly, while the central dispatch system 310 is shown as being in communication with two local dispatch systems 312, the central dispatch system 310 may alternatively be in communication with more or fewer local dispatch systems 312.

In a further aspect, the deployment systems 314 may take various forms. In general, the deployment systems 314 may take the form of or include systems for physically launching one or more of the UAVs 304. Such launch systems may include features that provide for an automated UAV launch and/or features that allow for a human-assisted UAV launch. Further, the deployment systems 314 may each be configured to launch one particular UAV 304, or to launch multiple UAVs 304.

The deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, the deployment systems 314 and their corresponding UAVs 304 (and possibly associated local dispatch systems 312) may be strategically distributed throughout an area such as a city. For example, the deployment systems 314 may be strategically distributed such that each deployment system 314 is proximate to one or more payload pickup locations (e.g., near a restaurant, store, or warehouse). However, the deployment systems 314 (and possibly the local dispatch systems 312) may be distributed in other ways, depending upon the particular implementation. As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, the UAV system 300 may include or have access to a user-account database 316. The user-account database 316 may include data for a number of user accounts, and which are each associated with one or more persons. For a given user account, the user-account database 316 may include data related to or useful in providing UAV-related services. Typically, the user data associated with each user account is optionally provided by an associated user and/or is collected with the associated user's permission.

Further, in some embodiments, a person may be required to register for a user account with the UAV system 300, if they wish to be provided with UAV-related services by the UAVs 304 from UAV system 300. As such, the user-account database 316 may include authorization information for a given user account (e.g., a username and password), and/or other information that may be used to authorize access to a user account.

In some embodiments, a person may associate one or more of their devices with their user account, such that they can access the services of UAV system 300. For example, when a person uses an associated mobile phone, e.g., to place a call to an operator of the access system 302 or send a message requesting a UAV-related service to a dispatch system, the phone may be identified via a unique device identification number, and the call or message may then be attributed to the associated user account. Other examples are also possible.

### V. Illustrative Payload Delivery Systems

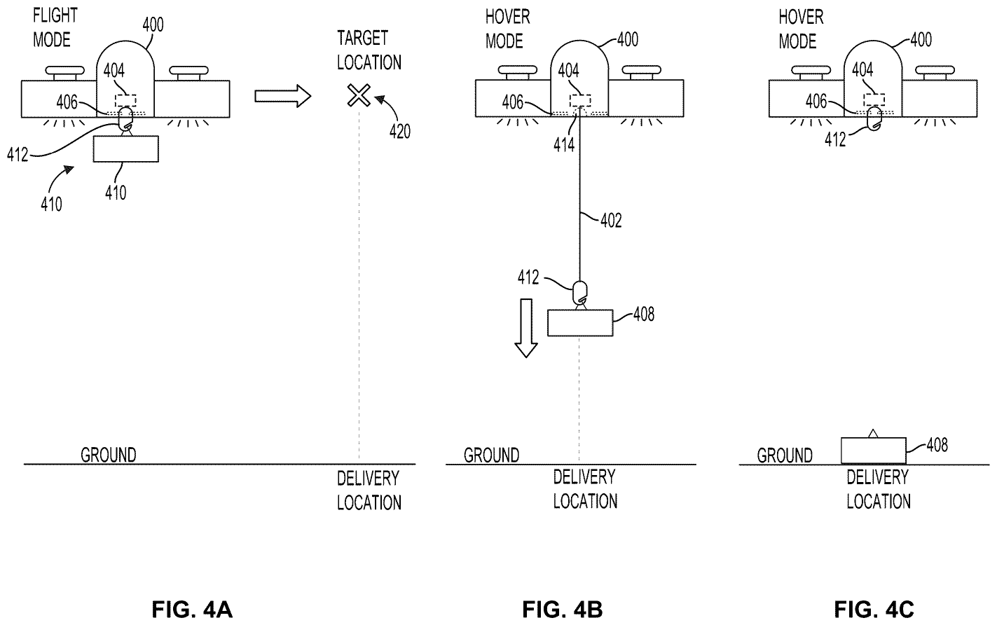

FIGS. 4A, 4B, and 4C show a UAV 400 that includes a payload delivery system 410 according to an example embodiment. As shown, payload delivery system 410 for UAV 400 includes a tether 402 coupled to a spool 404, a payload latch 406, and a payload 408 coupled to the tether 402 via a payload coupling apparatus (or payload retriever) 412. The payload latch 406 can function to alternately secure payload 408 and release the payload 408 for delivery. For instance, as shown, the payload latch 406 may take the form of one or more pins that can engage a portion of the payload 408. Inserting the pins of the payload latch 406 into the payload coupling apparatus 412 may secure the payload coupling apparatus 412 within a receptacle 414 on the underside of the UAV 400, thereby preventing the payload 408 from being lowered from the UAV 400. In some embodiments, the payload latch 406 may be arranged to engage the spool 404 or the payload 408 rather than the payload coupling apparatus 412 in order to prevent the payload 408 from lowering. In other embodiments, the UAV 400 may not include the payload latch 406, and the payload delivery apparatus may be coupled directly to the UAV 400.

In some embodiments, the spool 404 can function to unwind the tether 402 such that the payload 408 can be lowered to the ground with the tether 402 and the payload coupling apparatus 412 from UAV 400. The payload 408 may itself be an item for delivery, and may be housed within (or otherwise incorporate) a parcel, container, or other structure that is configured to interface with the payload latch 406. In practice, the payload delivery system 410 of UAV 400 may function to autonomously lower payload 408 to the ground in a controlled manner to facilitate delivery of the payload 408 on the ground while the UAV 400 hovers above.

As shown in FIG. 4A, the payload latch 406 may be in a closed position (e.g., pins engaging the payload coupling apparatus 412) to hold the payload 408 against or close to the bottom of the UAV 400, or even partially or completely inside the UAV 400, during flight from a launch site to a target location 420. The target location 420 may be a point in space directly above a desired delivery location. Then, when the UAV 400 reaches the target location 420, the UAV's control system (e.g., the tether control module 216 of FIG. 2) may toggle the payload latch 406 to an open position (e.g., disengaging the pins from the payload coupling apparatus 412), thereby allowing the payload 408 to be lowered from the UAV 400. The control system may further operate the spool 404 (e.g., by controlling the motor 222 of FIG. 2) such that the payload 408, secured to the tether 402 by a payload coupling apparatus 412, is lowered to the ground, as shown in FIG. 4B.

Once the payload 408 reaches the ground, the control system may continue operating the spool 404 to lower the tether 402, causing over-run of the tether 402. During over-run of the tether 402, the payload coupling apparatus 412 may continue to lower as the payload 408 remains stationary on the ground. The downward momentum and/or gravitational forces on the payload coupling apparatus 412 may cause the payload 408 to detach from the payload coupling apparatus 412 (e.g., by sliding off a hook of the payload coupling apparatus 412). After releasing payload 408, the control system may operate the spool 404 to retract the tether 402 and the payload coupling apparatus 412 toward the UAV 400. Once the payload coupling apparatus reaches or nears the UAV 400, the control system may operate the spool 404 to pull the payload coupling apparatus 412 into the receptacle 414, and the control system may toggle the payload latch 406 to the closed position, as shown in FIG. 4C.

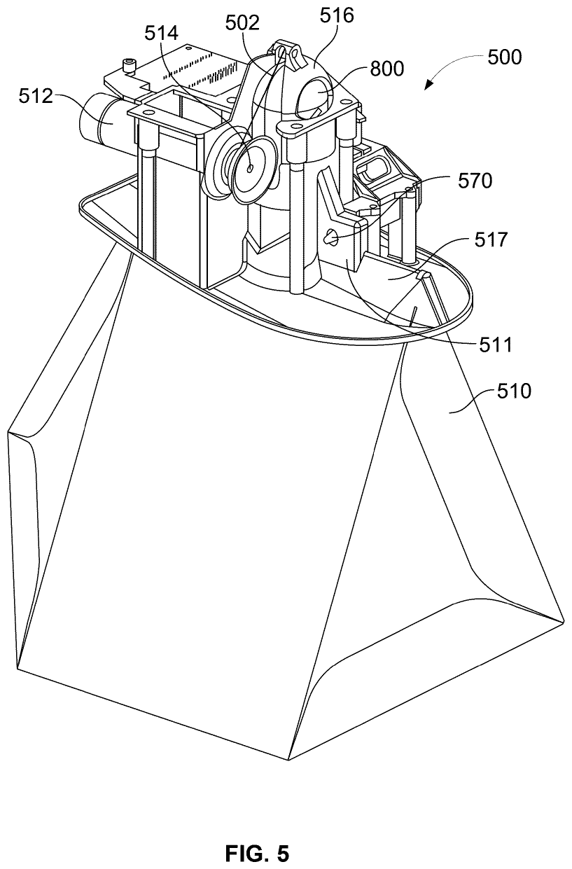

FIG. 5 shows a perspective view of a payload delivery apparatus 500 including payload 510, according to an example embodiment. The payload delivery apparatus 500 is positioned within a fuselage of a UAV and includes a winch 514 powered by motor 512, and a tether 502 spooled onto winch 514. The tether 502 is attached to a payload coupling apparatus or payload retriever positioned within a payload retriever receptacle 516. A payload 510 is secured to a payload retriever (or payload coupling apparatus) 800. In this embodiment a top portion 517 of payload 510 is secured within the fuselage of the UAV. A locking pin 570 is shown extending through handle 511 attached to payload 510 to positively secure the payload beneath the UAV during high-speed flight.

FIG. 5 shows a payload 510 taking the shape of an aerodynamic hexagonally-shaped tote, where the base and side walls are six-sided hexagons and the tote includes generally pointed front and rear surfaces formed at the intersections of the side walls and base of the tote providing an aerodynamic shape. In other embodiments, the payload may have other shapes or forms.

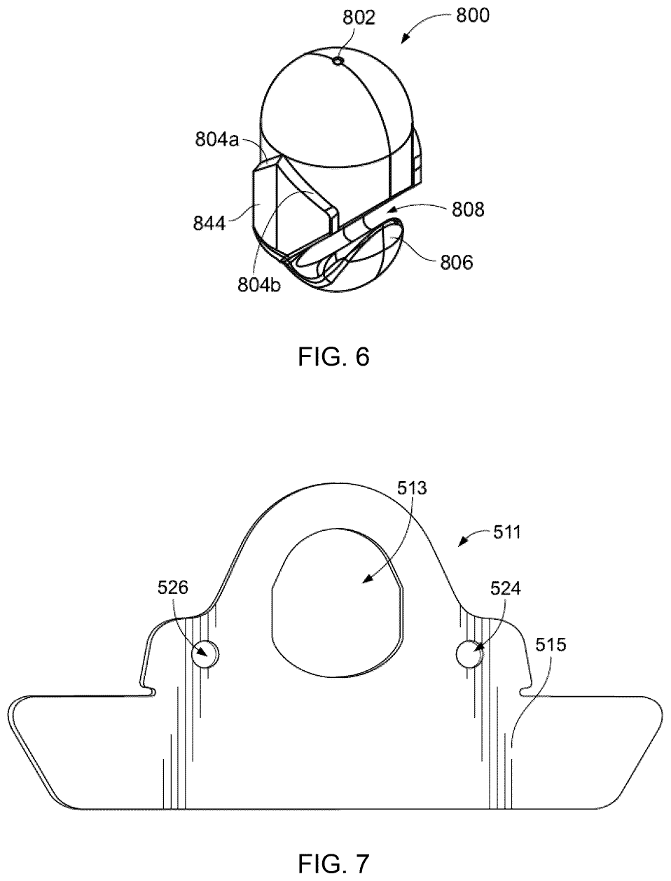

FIG. 6 is a perspective view of payload retriever 800 according to an example embodiment. Payload retriever 800 includes a tether mounting point 802 at the top of the payload retriever and a slot 808 adapted to receive a handle of a payload. Lower lip, or hook, 806 is formed beneath slot 808. Payload retriever 800 also includes outer protrusions 804 having helical cam surfaces 804a and 804b that are adapted to mate with corresponding cam mating surfaces to orient the payload coupling apparatus 800. Corresponding mating surfaces may be included within a receptacle in the fuselage of a UAV, or in a payload retrieval structure, as described in more detail below.

FIG. 7 is a side view of a handle 511 of a payload 510 configured to be carried by a UAV. The handle 511 includes an aperture 513 through which the hook of a payload retriever extends to suspend the payload during delivery or retrieval. The handle 511 includes a lower portion 515 that is secured to the top portion of a payload. Also included are holes 524 and 526 through which locking pins positioned within the fuselage of a UAV, may extend to secure the handle and payload in a secure position during high speed forward flight to a delivery location. In addition, holes 524 and 526 are also designed to receive pins of a payload holder for holding the payload in position on a payload retrieval apparatus. The handle may be comprised of a thin, flexible plastic material that provides sufficient strength to suspend the payload beneath a UAV during flight to a delivery site, and during delivery and/or retrieval of a payload. In practice, the handle may be bent to position the handle within a slot of a payload retriever.

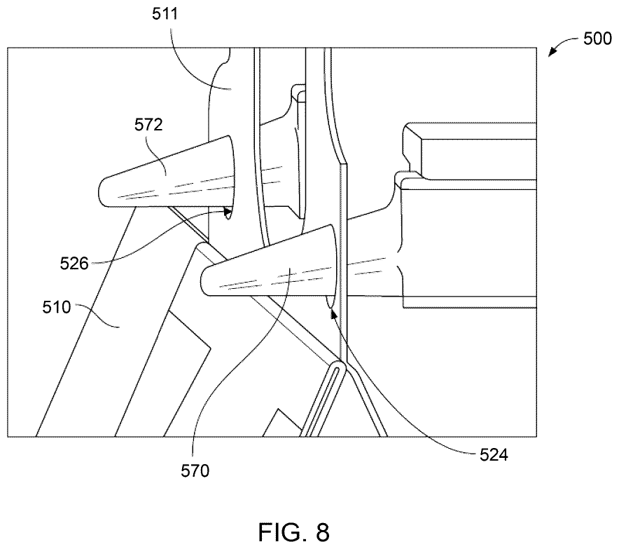

FIG. 8 shows a pair of pins 570, 572 extending through holes 524 and 526 in handle 511 of payload 510 to secure the handle 511 and top portion of payload 510 within the fuselage of a UAV. In this manner, the handle 511 and payload 510 may be secured within the fuselage of a UAV, or to a payload holder of a payload retrieval apparatus. In the illustrated embodiment, the pins 570 and 572 have a conical shape, which may help guide entry into the holes 524, 546. In other embodiments, the pins may have another shape, such as cylindrical. In some embodiments the pins 570 and 572 may completely plug the holes 524 and 526 of the handle 511 of payload 510, to provide a secure attachment of the handle and top portion of the payload within the fuselage of the UAV, or to secure the payload to a payload retrieval apparatus.

### VI. Illustrative Payload Retrieval Apparatuss

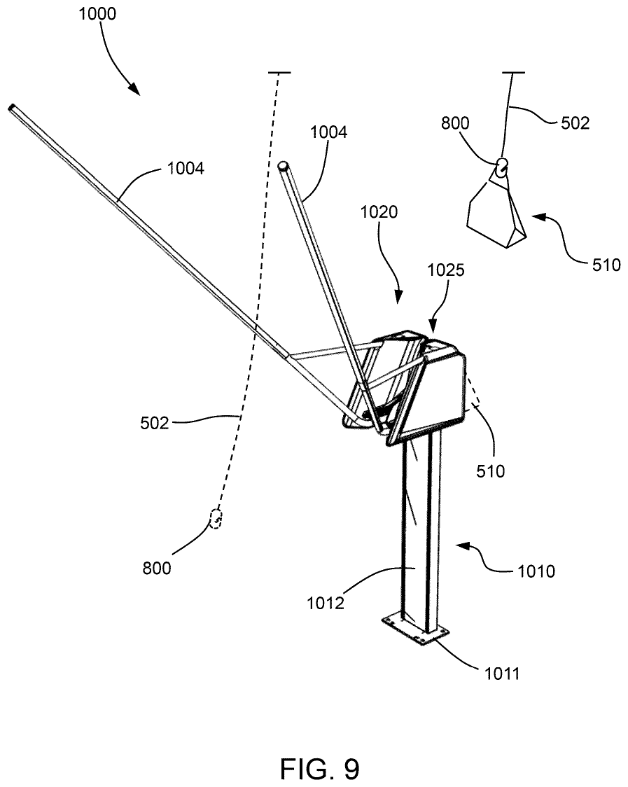

FIG. 9 is a perspective view of payload retrieval apparatus 1000 having a payload 510 positioned thereon, according to an example embodiment. The payload retrieval apparatus 1000 is configured to hold the payload 510 at the exit end of a retriever guide 1020 that directs a payload retriever 800 to the payload 510. The retriever guide 1020 is secured in place by a support structure 1010 that protects the retriever guide 1020 and holds the retriever guide 1020 at an elevated height. The elevated height of the retriever guide 1020 allows the payload retriever 800 to be pulled upward through the retriever guide 1020 by retracting the tether 502 into the UAV, for example by a winch. The payload retrieval apparatus 1000 also includes a pair of tether engagers 1002 that direct the tether 502 toward the inlet end of the retriever guide 1020, so that the payload retriever 800 is pulled into the retriever guide 1020 when the tether 502 is retracted. In FIG. 9, the dashed lines show the tether 502, payload retriever 800, and payload 510 before the payload retriever 800 passes through the payload retrieval apparatus 1000, while the solid lines show tether 502, payload retriever 800, and payload 510 after the payload 510 has been retrieved.

The support structure 1010 of the payload retrieval apparatus 1000 includes a frame for supporting the retriever guide 1020 and may include a pedestal 1012 to hold the retriever guide 1020 at an elevated height. Based on the construction of the pedestal 1012, the payload retrieval apparatus 1000 may be a permanent or non-permanent structure placed at the payload retrieval site. For example, the pedestal may include a base 1011 that is attached to the underlying structure, such as a paved surface, or the pedestal may be positioned within a corresponding hole in the ground. Alternatively, if the payload retrieval apparatus 1000 is mobile, it may include wheels or another mobile structure at the bottom of the pedestal 1012. Portions of the payload retrieval apparatus 1000, such as tether engagers 1004 described below, may be disassembled or folded, to provide for ease of transport or a smaller footprint when not in use.

The retriever guide 1020 includes a channel 1022 that guides the payload retriever 800 toward the payload 510. As previously stated, the payload retriever 800 is drawn through the payload retrieval apparatus 1000 by a tether 502. Accordingly, to accommodate the tether 502, the retriever guide 1020 includes a tether slot 1025 along the top. As the payload retriever 800 is guided through the channel 1022, the tether 502 slides along the tether slot 1025.

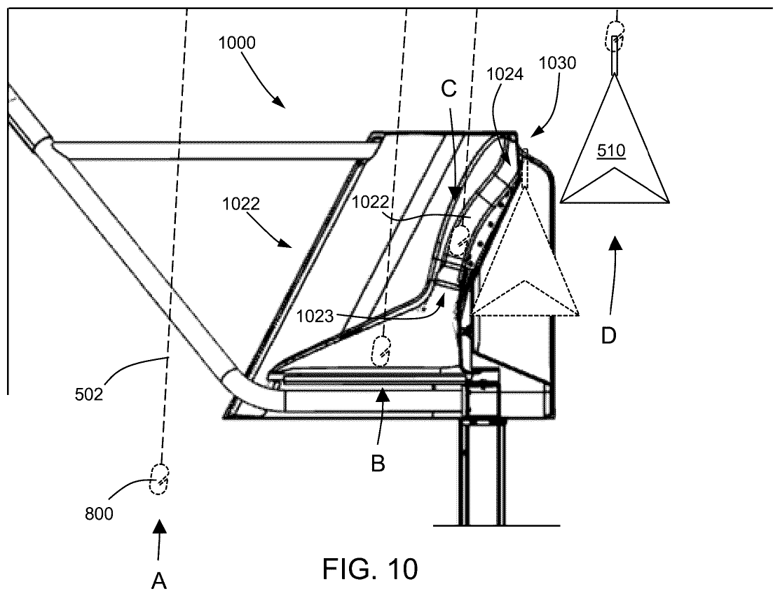

FIG. 10 shows a sequence of steps A-D performed in the retrieval of payload 510 from the payload retrieval apparatus 1000, shown in FIG. 9. As shown, the payload retrieval apparatus 1000 includes a payload holder 1030 that holds the payload 510 at the end of the channel 1022 of the retriever guide 1020. The steps shown in FIG. 10 illustrate the payload retriever 800 as it moves through the channel 1022 of the retriever guide 1020 from an inlet end 1023 of the channel 1022 to an exit end 1024 of the channel 1022. The payload holder 1030 is positioned at the exit end 1024 of the channel 1022, such that the payload retriever 800 receives the payload 510 as the payload retriever 800 leaves the retriever guide 1020. At point A in the sequence of steps shown from left to right, payload retriever 800 is shown suspended at the end of tether 502, with the payload retriever 800 below the retriever guide 1020 and the tether 502 between the tether engagers 1004. As the tether 502 moves to the right, the tether engagers 1004 and the inlet end of the retriever guide 1020 constrain the tether 502 so that the payload retriever 800 ends up under the retriever guide 1020.

As the tether 502 is retracted upward, the payload retriever 800 enters the retriever guide 1020 of the payload retrieval apparatus, as shown at point B. With continued retraction of the tether 502, the payload retriever 800 is drawn through the channel 1022 of the retriever guide 1020, as shown at point C. As the payload retriever 800 exits the channel 1022, it engages a handle 511 of the payload 510 and the payload retriever 800 removes the payload 510 from the payload holder 1030. After removal of payload 510 from the payload holder 1030, at point D of the sequence, payload 510 is suspended from tether 502 with handle 511 of payload 510 secured to the payload retriever 800. The payload 510 and tether 502 may be then winched up to the UAV and flown for subsequent delivery at a payload delivery site.

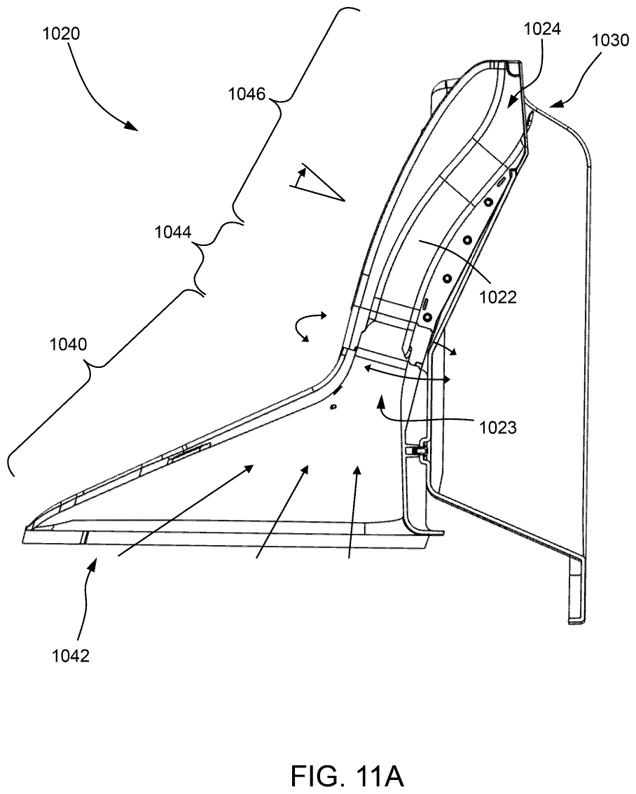

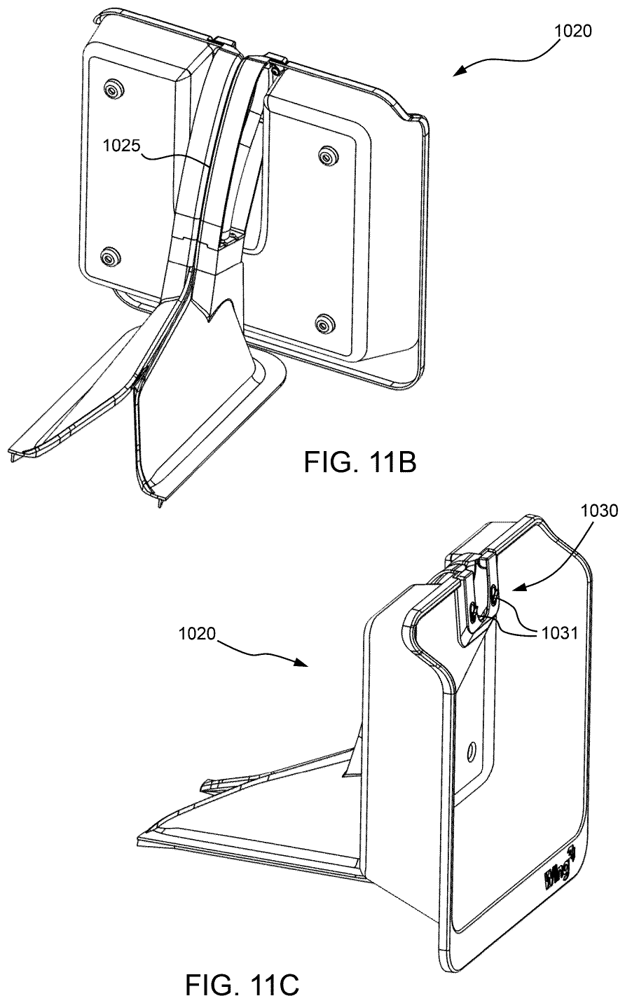

FIGS. 11A-11C illustrate the retriever guide 1020 of FIG. 9 in isolation from the support structure 1010 and other parts of the payload retrieval apparatus 1000. FIG. 11A shows a cross-sectional side view of the retriever guide 1020 that illustrates various functional components of the retriever guide 1020 that interact with a payload retriever in different ways as the payload retriever passes through the retriever guide 1020. As explained in more detail below, the retriever guide includes a funnel 1040, a rotator 1044, an angle adjuster 1046, and a payload holder 1030. FIG. 11B shows a perspective view of the inlet side of the retriever guide 1020 and more clearly shows the tether slot 1025 that extends along the channel of the retriever guide and allows the tether to extend into the channel and pull the payload retriever. FIG. 11C shows a perspective view of the exit side of the retriever guide 1020. A pair of hooks 1031, 1032 that form the payload holder 1030 can be seen on either side of the exit end 1024 of the channel. FIGS. 11A-11C also show a package bay 1048 that is formed as part of the retriever guide 1020. The package bay 1048 provides a partially enclosed area beneath the payload holder 1030 for protecting the payload from wind or other environmental hazards.

As shown in FIG. 11A, the funnel 1040 forms the inlet end 1023 of the channel 1022 or retriever guide 1020. The funnel 1040 is configured to guide the payload retriever into the channel 1022. The funnel 1040 has a wide mouth 1042 that opens downward and forms the inlet to the funnel 1040. The area surrounded by the mouth 1042 is configured to be substantially larger than the cross-sectional area of the payload retriever, such as at least 500% larger, so that the payload retriever can enter the retriever guide 1020 from various positions under the funnel 1040, as illustrated by the arrows that point into the funnel 1040. From the large open mouth 1042, the funnel 1040 tapers inward to the inlet end 1023 of the channel 1022, which has a smaller opening that is configured to more closely correspond to the size of the payload retriever.

As illustrated in FIG. 11A, the retriever guide 1020 also includes a rotator 1044 that is configured to rotate the payload retriever about the direction of travel of the payload retriever as it moves through the channel 1022. This rotation may also be understood as rotation around an axis that is aligned with the tether when the payload retriever is hanging from the tether. In aviation, this rotation would be described as roll. The rotator 1044 includes components along the channel 1022 to provide the rotation of the retriever. The rotation of the payload retriever within the rotator 1044 is illustrated by the elliptical arrangement of arrows adjacent to the rotator 1044 in FIG. 11A.

In some embodiments, the rotator 1044 includes one or more guiding protrusions that are operable to engage corresponding surfaces of the payload retriever in order to rotate the retriever as it passes through the associated portion of the channel. Such protrusions may be configured as helical surfaces that form cams along an interior of the channel. When a corresponding surface of the payload retriever contacts a cam, it slides along the helical surface of the cam that borders the channel and is caused to rotate about the direction of travel. In other embodiments, the rotator includes other components that cause the payload retriever to rotate as it passes through the rotator. For example, in some embodiments, the rotator includes magnets that interact with corresponding magnets on the payload retriever in order to rotate the payload retriever. A rotator including other components that cause the retriever to rotate are also possible.

In some embodiments, the rotator 1044 is oriented so that the direction of travel through the rotator 1044 is substantially vertical, where the phrase substantially vertical is used herein to mean closer to vertical than to horizontal. For example, in some embodiments, the direction of travel along the channel 1022 through the rotator 1044 is inclined by at least 65°, for example in a range of 70° to 85°, such as around 75°. Because the force that pulls the payload retriever through the channel is imparted by the airborne UAV through the hanging tether, forces in the vertical direction may translate more readily to the payload retriever. In particular, in various embodiments, winching the retriever upward by retracting the tether may be an effective way to impart forces on the retriever in order to move the retriever through the channel. Thus, where the channel is directed more vertically, a larger component of the force on the retriever is utilized to move the payload retriever through the channel and less force is directed to lateral movement or sliding against the walls of the channel. On the other hand, as the retriever is drawn through the rotator, a portion of the force is redirected to impart rotation to the retriever. By having the rotator oriented more vertically, a larger percentage of the force may be available to rotate the payload retriever.

The retriever guide 1020 also includes an angle adjuster 1046, that reduces the angle of inclination of the channel 1022 toward an exit end 1024 of the channel 1022. The change in angle imparted by the angle adjuster 1046 is illustrated by the icon of an angle adjacent to the angle adjuster 1046 in FIG. 11A. This change in the angle of the channel 1022 both tilts the retriever forward and increases the forward movement of the retriever as the retriever nears the exit end 1024 of the channel 1022. As a result, when the retriever nears the exit end 1024 of the channel 1022 it has a significant forward motion, which helps the retriever engage the payload. Then, as the retriever exits the channel it is pulled upward by the tether and can lift the payload off the payload holder 1030.

FIG. 12 illustrates a payload retriever 800 leaving the channel 1022 of the retriever guide 1020 and in the process of retrieving the payload 510. The handle 511 of payload 510 is secured on the payload holder 1030 and the top of the handle 511 was in the path of the payload retriever 800. In this embodiment, the handle 511 is flexible and the payload retriever 800 is shown contacting the handle 511 and bending it back as the payload retriever is pulled through the channel 1022. As the payload retriever 800 continues to be pulled by the tether 502, it will rotate upward and the handle 511 will be caught in the slot 808 of the payload retriever 800. The payload 510 is then lifted off the payload holder 1030 and removed from the payload retrieval apparatus.

In addition to the aforementioned functional components of the retriever guide, the retriever guide may include other components that interact with the payload retriever or provide other functionality. Further, the illustrated procedure of removing the payload from the payload retrieval apparatus is merely one of various ways in which the payload may be retrieved by the UAV.

### VII. Example Cleaning Method and Cleaning Structures

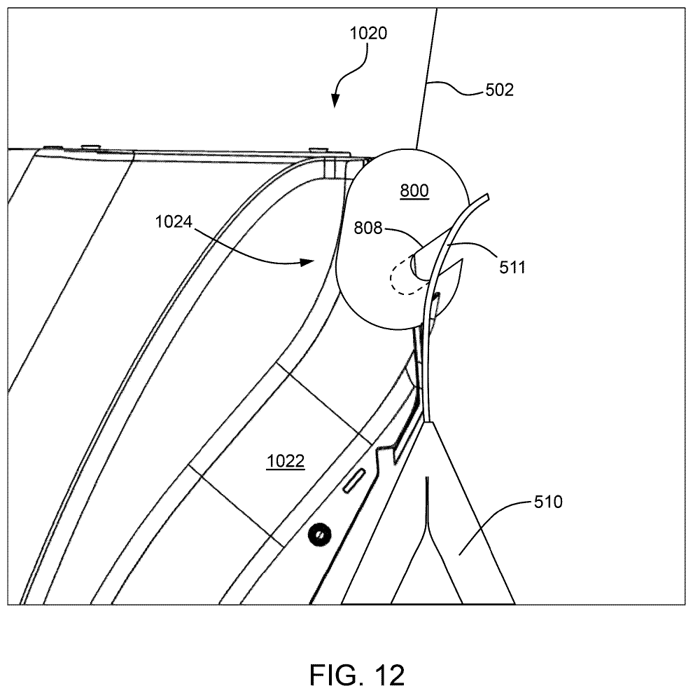

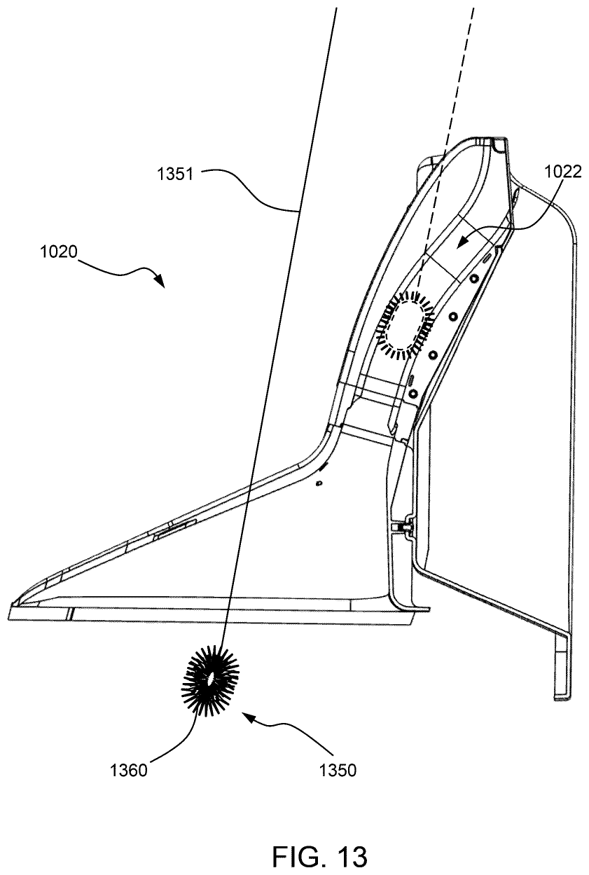

FIG. 13 illustrates the use of a cleaning structure 1350 to clean the retriever guide 1020 of a payload coupling apparatus, particularly internal surfaces of a channel 1022 of the retriever guide 1020. The cleaning structure 1350 is attached to a tether 1351 that is suspended from a UAV and is drawn through the retriever guide 1020 in a manner similar to a payload retriever, as described above. Solid lines in FIG. 13 show the cleaning structure 1350 below a funnel of the retriever guide 1020 and ready to be drawn through the channel 1022. The cleaning structure 1350 is also shown in dashed lines as it is moving through the channel.

Although the cleaning structure 1350 moves through the retriever guide in a manner similar to the payload retriever (800) described above, rather than being configured to secure a payload, the cleaning structure 1350 includes a cleaning component 1360 that is adapted to remove dust and debris from the internal surfaces of the channel 1022. Alternatively, in some embodiments, the cleaning structure may be configured to retrieve a payload in addition to cleaning the retriever guide. For example, in some embodiments, the main body may include a slot configured to receive a handle of a payload in addition to supporting a cleaning component. For example, a cleaning component may be provided at the upper end and/or lower end of the main body while a slot for a payload is included toward the center of the main body.

The cleaning component 1360 shown in FIG. 13 is configured as a plurality of bristles that extend radially outward. The bristles brush the inside of the channel 1022 as the cleaning structure 1350 is drawn through the retriever guide 1020. Other embodiments of the cleaning structure may include one or more cleaning components having various different configurations.

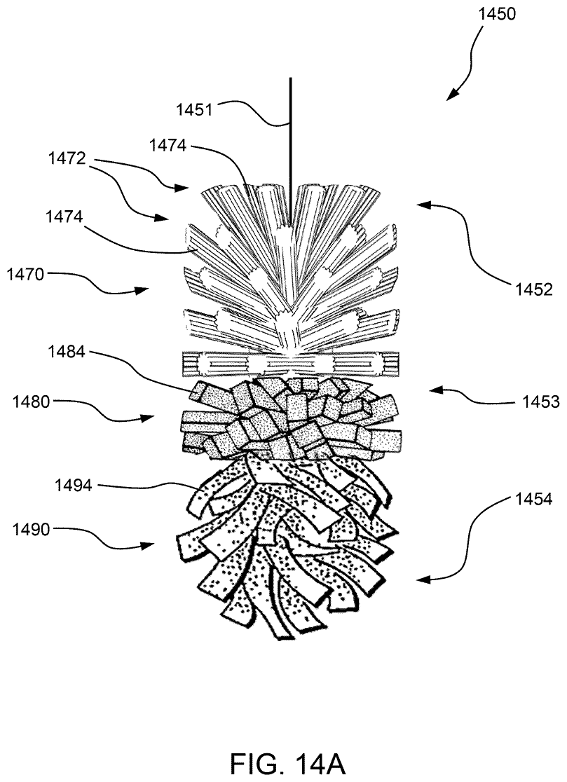

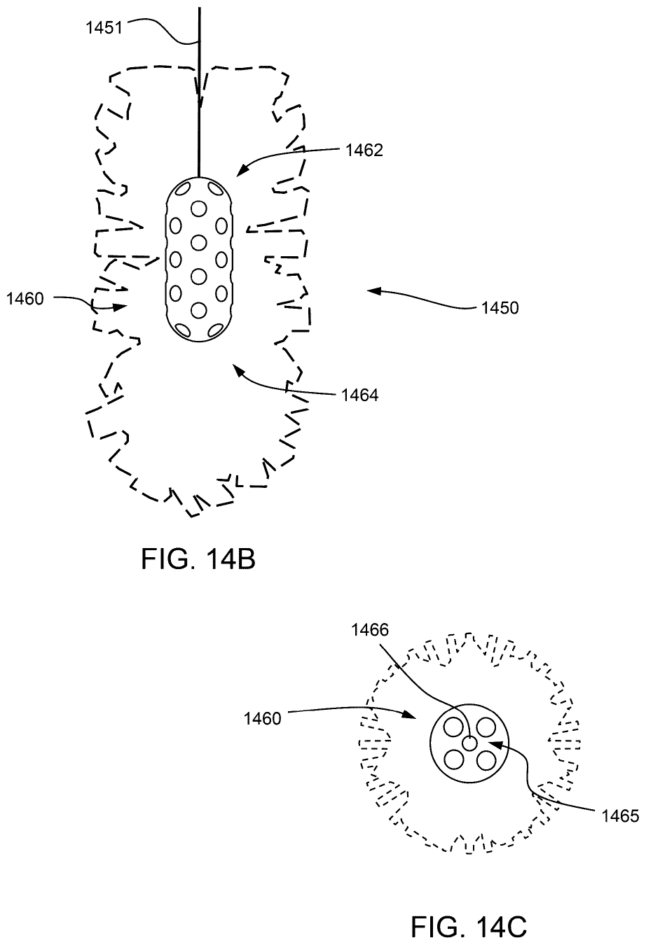

For example, FIGS. 14A-14C illustrate a cleaning structure 1450 in accordance with an embodiment of the disclosure that includes three cleaning components. The cleaning structure 1450 includes a main body 1460 (FIGS. 14B and 14C) and the three cleaning components 1470, 1480, 1490 are supported by and disposed around the main body 1460. FIG. 14B shows only an outline of the cleaning components so that the main body 1460 is visible. As shown in FIG. 14B, the main body 1460 is longer than it is wide and includes an upper end 1462 and a lower end 1464. A tether 1451 is attached to the main body 1460 of the cleaning structure 1450 and is operable to pull the cleaning structure 1450 so that it may be drawn through a retriever guide of a payload retrieval apparatus, as discussed further below. The tether 1451 extends upward from a tether attachment point 1465 on the upper end 1462 of the main body 1460.

FIG. 14C shows a top view of the cleaning structure 1450. Similar to FIG. 14B, only an outline of the cleaning components is depicted so that the main body 1460 is visible. The main body 1460 of the depicted cleaning structure 1450 of FIG. 14 has a circular cross section and is formed by an outer shell. The tether attachment point 1465 includes an aperture 1466 in the main body 1460 at its upper end 1462. As explained further below, in other embodiments the main body has other configurations and may or may not include an aperture for the tether.

The term tether attachment point, as used herein, refers to the point on the main body from which the tether extends. In some embodiments, the tether is anchored to the main body at the tether attachment point. For example, in some embodiments, the tether extends through an aperture in the main body and includes a stopper that does not slip through the aperture. Likewise, in some embodiments the tether is secured to a structure, such as a hook, at the tether attachment point. In other embodiments, the tether is anchored at another location and passes through the tether attachment point. For example, in some embodiments, the tether extends through an aperture in the main body and is anchored on a structure, such as a frame, inside the interior of the main body.

As shown in FIG. 14C, the cleaning components extend outward from the main body 1460. Each of the cleaning components 1470, 1480, 1490 has a flexible construction allowing at least some of the cleaning components to fit into crevices and grooves in the channel of the payload retrieval apparatus in order to remove dirt and/or debris. To push the cleaning components into such crevices and grooves, the overall diameter of the cleaning components may be slightly larger than the diameter of the channel. In the embodiment shown in FIGS. 14A-14C, each of the cleaning components 1470, 1480, 1490 extends circumferentially around the main body 1460 so as to encircle the main body. As a result, these cleaning components 1470, 1480, 1490 are configured to clean the entire interior surface of the channel. In other embodiments, the cleaning structure may include one or more cleaning components that are distributed in segments around the main body and positioned to clean particular areas of the channel.

As shown in FIG. 14A, cleaning structure 1450 includes a first cleaning component 1470 at an upper end 1452, a second cleaning component 1480 around its middle section 1453, and a third cleaning component 1490 at a lower end 1454. The first cleaning component 1470 is formed of a plurality of bundles 1472 of bristles 1474 extending both upward and radially outward from the main body 1460. Such bristles 1474 may be adapted to dislodge dirt and debris that has built up on the channel surfaces. The second cleaning component 1480 is formed of a plurality of sponge elements 1484 that extend radially outward from the center of the main body 1460. The sponge elements 1484 may be saturated in a cleaning solution and may be adapted to apply the cleaning solution to interior surfaces of the channel and wipe the channel clean. The third cleaning component 1490 is formed of a plurality of textile strands 1494, such as microfiber strands. Such strands may be adapted to trap any remaining liquid and dirt as the claiming structure 1450 passes through the channel.

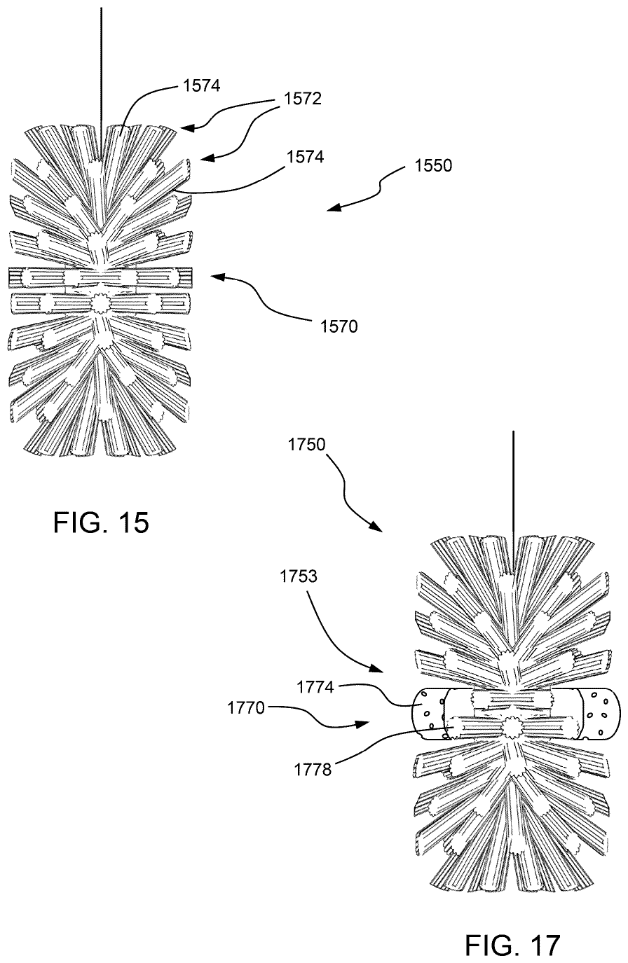

While cleaning structure 1450 includes three cleaning components, other embodiments of the cleaning structure of the disclosure include more or fewer cleaning components. For example, FIG. 15 shows a cleaning structure 1550 that includes a single cleaning component 1570 formed of a plurality of bundles 1572 of bristles 1574 that extend upward, outward, and downward from the main body, which is obscured from view in FIG. 15.

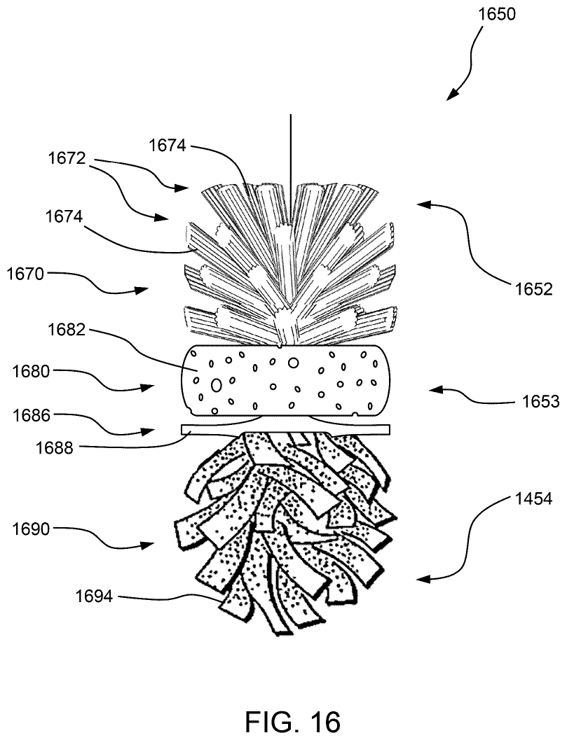

Likewise, FIG. 16 illustrates a cleaning structure 1650 with four cleaning components, 1670, 1680, 1690, and 1686. The first cleaning component 1670 is disposed at the upper end 1652 of the cleaning structure 1650 and is formed by a plurality of bundles 1672 of bristles 1674 that extend upward and outward from the main body. A second cleaning component 1680 is disposed around a middle section 1653 of the cleaning structure 1650 and is formed by a sponge 1682 that encircles the main body of the cleaning structure. A third cleaning component 1686 is positioned just below the second cleaning component 1680 and is formed by a squeegee 1688 that encircles the main body. A fourth cleaning component 1690 is disposed at the lower end 1654 of the cleaning structure 1650 and is formed by a plurality of textile strands 1694 that hang from the lower end 1654 of the cleaning structure 1650.

In cleaning structures 1450, 1550, and 1650, each of the cleaning components is formed by either a single element or by a plurality of the same types of cleaning elements (e.g., bristles, strands) that are positioned around the main body. In other embodiments, a cleaning component of the cleaning structure may include several different types of cleaning elements positioned around the main body. For example, cleaning structure 1750, shown in FIG. 17 includes a first cleaning component 1770 disposed at a middle section 1753 of the cleaning structure 1750 that includes both sponge elements 1774 and bristle elements 1778 spaced around the circumference of the main body of the cleaning structure.

The cleaning structures of the disclosure may include any combination of various different cleaning components. In some embodiments, a cleaning component includes bristles to form a brush component. The configuration of the bristles in the brush component may be arranged in various different ways. In some embodiments, the bristles are formed in bundles that collectively extend in a similar direction. Such bundles may be useful to target specific grooves and crevices in the channel of the retriever guide. In other embodiments, the bristles are evenly distributed around the main body of the cleaning structure. Further, in some embodiments, the bristles are organized in some sections that are bundled and some sections that are evenly distributed.

In some embodiments, the bristles have a consistent length over the surface of the cleaning structure. In other embodiments, the bristles are arranged in sections of a first length and sections of a second length. Such sections of differing length may be useful to target particular grooves or crevices in the channel. Further, in some embodiments, bristles of varying length are dispersed throughout sections or the entire cleaning component, such that two adjacent bristles may be of different length. Such variation in bristle length can help clean areas of the channel with rough or undulating surfaces. In some embodiments, the bristles extend outward from the main body in a relatively uniform manner, such as radially from the center of the cleaning structure. In other embodiments, the bristles extend outward from the surface of the main body in a range of angles.

The bristles of a cleaning component including, or formed as, a brush component may be formed of various different materials. For example, the bristles may be formed of plastic, metal, or natural fibers. Plastic bristles may be formed of nylon or polypropylene, for example. Nylon bristles are particularly resilient and maintain their stiffness under varying temperatures, making them ideal for outdoor use where conditions can change dramatically. They are also resistant to abrasion, chemicals, and moisture, ensuring a long service life. Polypropylene bristles have similar characteristics but may be lighter and more economical. Examples of metal bristles include steel and brass. Examples of natural fiber bristles include plant-based or animal-based fibers. It is also possible that a brush component includes bristles of more than one material.

In some embodiments, the cleaning structure includes a cleaning component formed as a sponge component. Such a sponge component may include a single sponge element extending outward from the main body of the cleaning structure or several sponge elements in a bundle, such as is shown in cleaning structure 1450. Sponge elements in embodiments of the disclosure may be formed from various different materials, including synthetic materials, such as polyurethane foam or polyester. Alternatively, a sponge element may be made of natural materials, such as plant fibers, cellulose, or natural sponges. Further, combinations of synthetic and natural materials may be used to form a sponge element for use in the cleaning structure.

In some embodiments, the cleaning structure includes a cleaning component that has textile strands to form a mop component. The textile strands may have various different shapes and configurations, such as twisted and/or looped. Twisted strands may increase the surface area of the strands with respect to their length. Looping the strands can increase the likelihood of catching debris and prevent the strands from unraveling. In various embodiments, the strands may have uniform or different sizes, such as different thicknesses and lengths.

The strands may be of various different materials including polyester, nylon, microfiber, cotton or other synthetic or natural materials. Different materials may provide different advantages. As one example, microfiber is highly effective for attracting and holding dust, dirt, and moisture due to its high surface area and the electrostatic properties of the fibers. Further, the strands may be made of more than one material. For example, the strands may have a textile body formed of one material and abrasive elements, such as rubber gripping elements, disposed on the surface of the textile body.

In some embodiments, the cleaning structure may include a cleaning component with dusting elements. Such dusting elements may include strands formed of a first material and bundles of fibers of a second material. For example, the dusting elements may include a layer of strands of hydrophilic non-woven material, and bundles of fibers including hydrophilic and/or hydrophobic fibers. Such dusting elements may be effective for trapping and removing small dirt particles.

In some embodiments, the cleaning structure may include a cleaning component formed as a squeegee. Embodiments of a cleaning component formed as a squeegee include a flexible blade element adapted to wipe dirt and liquids from the surface being cleaned. The squeegee may extend around the full circumference of the cleaning structure or around sections of the cleaning structure. The width of the flexible blade may be uniform around the circumference of the cleaning structure or may vary. The blade may be formed of various different materials, including silicone, neoprene, polyurethane, rubber, leather, or other materials.

The main body of the cleaning structure of the disclosure may have various configurations. The main body may be formed of various different materials, including plastic, metal, wood, bamboo, or other materials. In some embodiments, the main body is formed as a hollow shell with or without apertures to the interior of the shell. In other embodiments, the main body has a solid construction with an outer surface to hold cleaning components. Still in other embodiments, the main body is formed of a twisted material, such as twisted wire that may be used to anchor cleaning components, such as bristles, within the twists of the main body. Further, in some embodiments, the main body may be formed of a combination of such structures.

Cleaning components of the cleaning structures of the disclosure may be secured to the main body of the cleaning structure in various different ways. In some embodiments, the cleaning components extend through apertures in the main body, and are anchored in the interior of the main body, such as to one another or to a frame. In some embodiments, the cleaning components are attached to an exterior surface of the main body, for example using adhesive or a removable fastener pair, such as hook and loop fastener. Further, in some embodiments, as stated above, the cleaning components may be wedged within parts of the main body, such as when the main body is formed of twisted wire. Further still, in some embodiments, the cleaning component may be integrally formed with the main body. For example, in some embodiments, the cleaning component is formed by longitudinal protrusions extending outward from the main body. If integrally formed with the main body, the material thickness of the protrusions may allow the protrusions to have sufficient flexibility to form a cleaning operation.

In some embodiments, the cleaning structure is configured to carry a liquid in order to dispense the liquid to surfaces of the payload retrieval apparatus. Such a liquid may include a cleaning solution for removing dirt from the surfaces and/or a lubricant to reduce friction of a payload retriever against the surfaces of the channel. The liquid may be held in one or more cleaning components of the cleaning structure, such as a sponge, or may be held in a reservoir in the cleaning structure, such as in the main body.

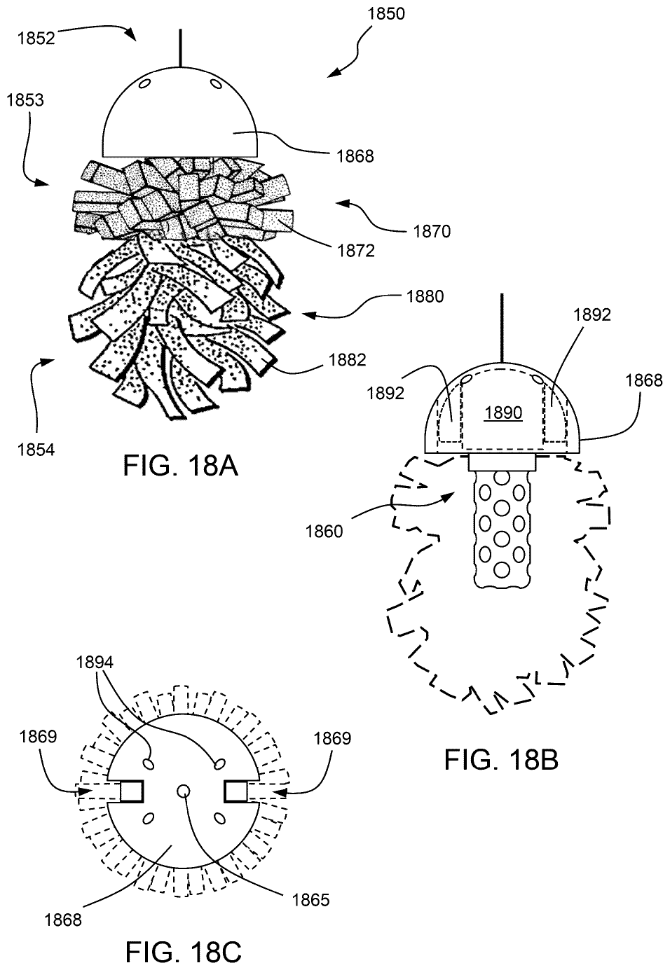

An embodiment of a cleaning structure 1850 that includes a reservoir 1890 is shown in FIGS. 18A-18C. Cleaning structure 1850 includes a main body 1860 that has a cap 1868 at an upper end 1852 of the cleaning structure. A first cleaning component 1870 including a plurality of sponge elements 1872 is disposed around a middle section 1853 of the cleaning structure. Likewise, a second cleaning component 1880 including a plurality of textile strands 1882 is disposed around the lower end 1854 of the cleaning structure 1850. As explained in more detail below, the cap 1868 is configured to spray solution onto the approaching inner surfaces of the channel as the cleaning component is drawn through the channel. The cleaning components 1870, 1880 may then spread the liquid across the inner surfaces of the channel and clean or lubricate the channel. While the illustrated embodiment sprays upward, the liquid may also be delivered laterally outward or directly onto a cleaning component.

The cap 1868 includes the tether attachment point 1865 and is adapted to guide the cleaning structure 1850 through the channel of a retriever guide. A pair of slots 1869 are arranged on opposing sides of the cap 1868 and are configured to ride along a ridge as the cleaning component passes through the channel of the retriever guide. Within each of the slots 1869 is a movable actuator 1892 that is adapted to engage the reservoir 1890 when they are pushed inward. Accordingly, an appropriate structure may be included in the channel of the retriever guide to press the actuators inward and deliver fluid from the reservoir. In some embodiments, the actuators are configured to compress the reservoir and push liquid out from the reservoir. In other embodiments, the reservoir may be configured to hold a packet, and the actuators are configured to break the packet, allowing liquid to seep out and move into the channel and onto the cleaning component(s). For example, the packet may be adapted to burst when it is compressed by an actuator, or may include a seal that is punctured by an actuator. Other configurations to release liquid from the reservoir are also possible.

In some embodiments, the actuators are mechanically coupled so that they only compress the reservoir when depressed together. Such a construction may decrease the likelihood that the actuators are depressed accidentally. In other embodiments, the actuators are operable independently. Further, in some embodiments, the cap includes a single actuator or more than two actuators.

As cleaning structure 1850 passes through a channel of a retriever guide a ridge that extends along its length may be positioned in one of the slots 1869 of the cap 1868 of the cleaning structure 1850 so a desired orientation of the cleaning structure 1850 is maintained as the cleaning structure 1850 passes through the channel. The channel may include a pair of projections that are adapted to compress the actuators 1892 as the cleaning structure 1850 is drawn past the projections, which may force liquid in a spray through orifices 1894 at the top of the cap 1868.

While cleaning structure 1850 includes a plurality of orifices at the top of the cap 1868 for spraying fluid ahead, in other embodiments, fluid may be dispensed from the reservoir in other ways. For example, in some embodiments, the fluid seeps out onto one or more cleaning components and is applied by the cleaning components. In other embodiments, the fluid is delivered laterally or behind the cleaning structure. Further, while the reservoir 1890 of cleaning structure 1850 is positioned at the upper end of the cleaning structure, in other embodiments, the reservoir may be positioned in the middle or at the lower end of the cleaning structure. For example, the cleaning structure may be configured to deliver fluid on the surfaces after they are cleaned. Further, although cleaning structure includes a single reservoir with one type of fluid, in other embodiments, the cleaning structure may include more than one type of fluid. For example, in some embodiments, the cleaning structure includes a first reservoir at an upper end that is configured to deliver cleaning solution, and a second reservoir at the lower end that is configured to deliver lubricant onto surfaces that have already been cleaned.

In another aspect, the disclosure provides a method of cleaning a retriever guide of a payload retrieval apparatus. The method includes initiating, by a controller of an aerial vehicle, a cleaning operation while the aerial vehicle is hovering above the payload retrieval apparatus. The cleaning operation includes controlling a motor to extend a tether from the aerial vehicle to lower a cleaning structure attached to the tether to a position below an inlet end of a channel of a retriever guide of the payload retrieval apparatus. For example, as shown in FIG. 13, cleaning structure 1350 is suspended on tether 1351 and positioned below the opening to channel 1022 of retriever guide 1020. The controller then controls either the flight controls of the aerial vehicle, the motor for the tether, or both, to draw the cleaning structure into the channel and pull the cleaning structure through the channel, as shown by the dashed lines in FIG. 13.

In some embodiments, the method may include drawing the cleaning structure through the retriever guide of the payload retrieval apparatus multiple times. By drawing the cleaning structure through the retriever guide more than once, additional dirt and debris may be removed from the apparatus. Further, in some embodiments, the manner in which the cleaning structure is drawn through the retriever guide may be altered between passes. For example, the cleaning structure may be arranged to be drawn through the retriever guide at different angles on different passes. Likewise, the cleaning structure may be drawn through the retriever guide at a first speed during a first pass and drawn through the retriever guide at a second speed during a second pass. Further, the speed at which the retriever guide is drawn through the retriever guide can also vary within a single pass through the retriever guide.

In some embodiments, the method also includes analyzing one or more operational parameters of the motor as the cleaning structure is drawn through the channel to determine whether the channel has been cleaned. For example, if the torque-speed curve of the motor, or the position-current profile of the motor exceeds a threshold at any point along the curve, the controller may identify the channel as requiring further servicing, for example because it is still dirty. In such a case, in response to the operational parameter (or parameters) of the motor, the controller initiates an additional cleaning operation where either the same aerial vehicle runs the cleaning structure through the payload retrieval apparatus again, or a signal is sent to a central dispatch to send another aerial vehicle to clean the payload retrieval apparatus. Alternatively, if the operational parameters of the motor appear normal, or below a certain threshold, the controller may identify the channel of the retriever guide as sufficiently clean and operational.

In yet another aspect, the disclosure provides a method of initiating a cleaning operation of a payload retriever apparatus. In such a method, a controller may analyze motor operational parameters corresponding to drawing a payload retriever through a payload retrieval apparatus. The operational parameters may be based on a single instance of drawing a payload retriever through a retriever guide, or multiple instances of drawing payload retrievers through a particular retriever guide. If one or more of the operational parameters, or an average of the operational parameters exceeds a threshold, such as the torque profile exceeding a threshold at a certain location within the retriever guide, the controller may identify the retriever guide as requiring maintenance. For example, the exceeding of the threshold may indicate that the retriever guide includes high friction surfaces or debris that is hindering movement of the payload retriever through the retriever guide. In response to identifying an abnormal motor operational parameter, the controller may initiate a cleaning operation using the cleaning structure. For example, a central dispatch system may dispatch an aerial vehicle with the cleaning structure of the disclosure for cleaning the corresponding payload retrieval apparatus.

### VIII. Conclusion

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures.

Additionally, while various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A cleaning structure for a payload retrieval apparatus comprising:
a main body including an upper end and a lower end, the upper end comprising a tether attachment point;
a first cleaning component extending outward from the main body, the first cleaning component having a flexible construction for fitting into crevices in the payload retrieval apparatus and defining a cleaning zone around the main body.

2. The cleaning structure of claim 1, wherein the first cleaning component includes a plurality of bristles extending in a ring around the main body.

3. The cleaning structure of claim 1, wherein the first cleaning component includes one or more sponges.

4. The cleaning structure of claim 3, wherein the one or more sponges are configured to hold a lubricant for dispensing onto an inner surface of a channel of the payload retrieval apparatus.

5. The cleaning structure of claim 1, wherein the first cleaning component includes collections of fibers extending from the main body.

6. The cleaning structure of claim 1, further comprising a second cleaning component attached to the main body.

7. The cleaning structure of claim 1, wherein the main body includes an outer shell, and the tether attachment point includes an aperture in a surface of the outer shell of the main body for receiving the tether.

8. The cleaning structure of claim 1, wherein a length of the main body from the upper end to the lower end is greater than a width of the main body.

9. The cleaning structure of claim 1, wherein the main body has a circular cross-section across a middle of the main body.

10. The cleaning structure of claim 1, further comprising a reservoir configured to dispense lubricant onto an inner surface of a channel of the payload retrieval apparatus.

11. A system for cleaning a payload retrieval apparatus, the system comprising:
an aerial vehicle;
a tether secured to the aerial vehicle;
a motor operable to deploy the tether from the aerial vehicle; and
a cleaning structure attached to the tether, the cleaning structure comprising:
a main body including an upper end and a lower end, the upper end comprising a tether attachment point;
a first cleaning component extending outward from the main body, the first cleaning component having a flexible construction for fitting into crevices in the payload retrieval apparatus and defining a cleaning zone around the main body.

12. The system of claim 11, wherein the first cleaning component includes a plurality of bristles extending in a ring around the main body.

13. The system of claim 11, wherein the first cleaning component includes one or more sponges.

14. The system of claim 11, wherein the first cleaning component includes collections of fibers extending from the main body.

15. The system of claim 11, further comprising a second cleaning component attached to the main body.

16. A method of cleaning a retriever guide of a payload retrieval apparatus, the method comprising initiating, by a controller, a cleaning operation comprising:
controlling a motor to extend a tether from an aerial vehicle so as to lower a cleaning structure attached to the tether to a position below an inlet end of a channel of a retriever guide of the payload retrieval apparatus;
controlling the position of the aerial vehicle and the motor to draw the cleaning structure into the inlet end of the channel of the retriever guide; and
controlling the motor to pull the cleaning structure through the channel of the retriever guide.

17. The method of claim 16, wherein the cleaning structure includes a main body and a cleaning component attached to the main body, and wherein the cleaning structure sweeps along an inner surface of the channel of the retriever guide.

18. The method of claim 16, further comprising determining, by a control system, an operational pattern of the motor as the cleaning structure is pulled through the channel of the retrieval guide; and
in response to the operational pattern of the motor, initiating an additional cleaning operation.

19. The method of claim 16, further comprising determining, by a control system, an operational pattern of the motor as the cleaning structure is pulled through the channel of the retrieval guide; and
identifying the channel of the retrieval guide as operational.
